(19) United States
(12) Patent Application Publication
(10) Pub. No.: US 2015/0032392 A1
(43) Pub. Date: Jan. 29, 2015

(54) CONDITION MONITORING OF ANTI-VIBRATION MOUNTS

(71) Applicant: GE ENERGY POWER CONVERSION TECHNOLOGY LIMITED, Rugby (GB)

(72) Inventor: Stuart Ian Bradley, Lutterworth (GB)

(21) Appl. No.: 14/379,019

(22) PCT Filed: Feb. 18, 2013
(86) PCT No.: PCT/EP2013/053172

§ 371 Date: Aug. 15, 2014

(30) Foreign Application Priority Data
Feb. 16, 2012 (EP) 12155835.7

(51) Int. Cl. G01M 13/00; G01H 17/00; G01K 13/00

(52) U.S. Cl. CPC G01M 13/00; G01K 13/00; G01H 17/00
USPC 702/56; 73/584; 374/142

(57) ABSTRACT

Monitoring the condition of an anti-vibration mount, e.g. a sandwich mount in which a plurality of elastomeric layers are interleaved with rigid plates. A set of effectiveness data is determined using input and output data measured or derived over a period of time. The effectiveness data is indicative of the effectiveness of the anti-vibration mount, in particular is dynamic stiffness. The input data is indicative of the amplitude of input vibrations that are applied to the anti-vibration mount and the output data is indicative of the amplitude of corresponding output vibrations of the anti-vibration mount (e.g. the vibrations that are transferred into an external support frame of the associated apparatus or equipment). The operating condition of the anti-vibration mount is monitored using the set of effectiveness data, e.g. by comparing successive sets of effectiveness data determined using input and output data collected over different time periods.

### TECHNICAL FIELD

Embodiments of the present invention relate to the condition monitoring of anti-vibration mounts, typically of the sort used in suspension structures for supporting the stator of a rotating electrical machine such as a motor or generator.

### BACKGROUND ART

Sandwich anti-vibration mounts are well known for industrial applications. For example, they can be located underneath diesel engines or generator sets to provide a resilient suspension. A typical sandwich mount consists of one or more elastomeric layers formed from rubber or polymer located between two rigid end plates. In some cases, a rigid plate is interleaved between adjacent elastomeric layers for increased loading capability. Sandwich mounts can be used either in compression or shear, or a combination of both. Sandwich mounts can be considered as having a damping characteristic and a dynamic stiffness (spring) characteristic.

A stator assembly for a rotating electrical machine will normally be mounted to an external support frame. Sandwich mounts can be used to minimise the amount of vibration transferred into the support frame, effectively decoupling the stator assembly from the support frame. More particularly, sandwich mounts can be located between the external support frame and a part of the stator such that they experience compression loading in a substantially tangential direction of the stator and radial shear loading in a substantially radial direction of the stator during operation of the rotating electrical machine.

The sandwich mounts are fitted within the external support frame or structure which makes them very difficult to visually inspect or monitor their condition. There is therefore a need for an improved method of condition monitoring.

### SUMMARY OF THE INVENTION

An embodiment of the present invention provides condition monitoring of an anti-vibration mount comprising the steps of: determining a first set of effectiveness data indicative of the effectiveness of the anti-vibration mount by: measuring or deriving input data indicative of the amplitude of input vibrations that are applied to the anti-vibration mount (e.g. from associated apparatus or equipment to which the mount is secured) and output data indicative of the amplitude of corresponding output vibrations of the anti-vibration mount (e.g. the vibrations that are transferred into an external support frame of the associated apparatus or equipment), the input and output data being measured or derived over a first period of time; and using the input and output data to determine the first set of effectiveness data; and monitoring the operating condition of the anti-vibration mount on the basis of the first set of effectiveness data.

Important and useful information on the operating condition of the anti-vibration mount can be obtained from just the first set of effectiveness data, i.e. on the basis of input and output data that is provided over just a first period of time. There is not always a need to compare the effectiveness data against successive sets of effectiveness data. However, in one example, the operating condition of the mount can be monitored by comparing successive sets of effectiveness data determined using input and output data collected over different time periods. Successive sets of effectiveness data are determined periodically at time intervals and then compared with one or more previous sets of effectiveness data, which are typically stored (e.g. in a suitable memory), so that any deterioration in the dynamic stiffness of the mount can be identified. More particularly, the condition monitoring can further comprise the steps of determining a second set of effectiveness data indicative of the effectiveness of the anti-vibration mount by measuring or deriving input data indicative of the amplitude of input vibrations that are applied to the anti-vibration mount and output data indicative of the amplitude of corresponding output vibrations of the anti-vibration mount, the input and output data being measured or derived over a second period of time, different from the first period of time. The input and output data measured or derived over the second period of time can be used to determine the second set of effectiveness data. Monitoring the operating condition of the mount can then be carried out on the basis of the first and second sets of effectiveness data. Further sets of effectiveness data can be determined in a similar manner. In another example, the first set of effectiveness data can be processed or analysed to see if the mount is meeting minimum requirements for dynamic stiffness or other operating characteristics.

In general terms it will be appreciated that the relationship between the amplitude of input vibrations and the corresponding output vibrations depends on how effective the anti-vibration mount is at minimising the transfer of vibrations. In other words, if the anti-vibration mount is operating correctly then the amplitude of the output vibrations should be significantly less than the amplitude of the input vibrations because of the damping effect provided by the anti-vibration mount. The effectiveness of the anti-vibration mount will typically decrease over time and one embodiment of the present invention provides a useful way of monitoring that effectiveness without the need for visual inspection, and also of allowing its service life to be predicted.

Sensors (typically high-frequency accelerometers) can be mounted at suitable locations at or adjacent the anti-vibration mount where they will experience the input and output vibrations. The sensors can be physically integrated into the anti-vibration mount or mounted to parts of an external support frame and associated apparatus or equipment to which the anti-vibration mount is secured. The input and output data necessary for condition monitoring can be obtained or derived from sensors that provide inter alia acceleration or amplitude measurements. For example, electronic equipment that is used to filter and process acceleration measurements can do the necessary integration. The sensors can be connected to external electronic equipment or instrumentation by any suitable wired (e.g. using cables) or wireless arrangement.

Input and output data will typically be collected over a period of time during which input vibrations are being applied to the mount, e.g. while the associated apparatus or equipment that is the cause of the input vibrations is operational. In practice, input and output data can be collected continuously or only during periods of time when input vibrations are being applied. The input and output data can be stored (e.g. in a suitable memory) before being used by a suitable processor unit to determine the effectiveness data. The time periods over which the input and output data is measured or derived to determine each set of effectiveness data can be discrete or overlapping. The input and output data can be collected in the time domain before optionally being converted into another domain, typically but not exclusively, the frequency domain, using any suitable transform (e.g. a fast Fourier transform (FFT), wavelet transformer or a modified Hilbert transform) for further processing.

The effectiveness of the anti-vibration mount will depend on its damping and its dynamic stiffness. Over the service life of the anti-vibration mount the effectiveness will deteriorate as a result of creep and fatigue, for example. Dynamic stiffness of the anti-vibration mount will depend on the frequency and amplitude (or displacement) of the input vibrations, and also on the operating temperature of the anti-vibration mount. The dynamic stiffness has a non-linear relationship with the frequency of the input vibrations and depends on internal resonances, standing waves and mass effects that vary with the operating condition of the anti-vibration mount. The fact that dynamic stiffness also depends on amplitude means that relationship between the input and output vibrations will depend on the amplitude of each input vibration, e.g. the anti-vibration mount may have a large dynamic stiffness for input vibrations having small amplitude and a small dynamic stiffness for input vibrations having large amplitude.

The input vibrations applied to the anti-vibration mount over a period of time will typically have several frequency components. The output vibrations will also have several frequency components, some of which will be the same as those of the input vibrations—but having different amplitudes as a result of the damping effect of the anti-vibration mount—but others can be introduced by the dynamic stiffness of the anti-vibration mount itself. For example, the output vibrations can include frequency components that are introduced by the anti-vibration mount as a result of mass effects that depend on the natural frequency of the elastomeric material (e.g. rubber or polymer layers) in the mount and/or standing wave effects. These higher order frequency effects can be particularly useful in monitoring the long-term deterioration in the physical properties of the anti-vibration mount, e.g. where the base polymer in the layers of elastomeric layers break down.

If the input and output data collected over a particular time period is converted into the frequency domain then the frequency components of the input and output vibrations can be selectively isolated. The effectiveness data can be derived using one or more of the frequency components of the input and output data. (If the input and output data is converted into a domain other than the frequency domain as mentioned above then components of the input and output vibrations in that transform domain can be selectively isolated and used to derive the effectiveness data. Any reference below to frequency components of the input and output data should be understood to mean components in any other transform domain where applicable.) In one example, the input and output data at just one of the frequency components can be isolated and then used to determine the set of effectiveness data for the particular period of time over which the input and output data was collected. If the anti-vibration mount is used to decouple the stator assembly of a rotating electrical machine (e.g. a motor or generator) from an external support frame then the chosen frequency component could be the pole pass frequency—which is equal to the slip frequency times the number of poles of the electrical machine—or the stator ovalling frequency, for example. However, it might be more typical for several frequency components, or even the entire frequency spectrum, of the input and output data to be used to determine the effectiveness data, in particular so that the additional effects that are introduced by the anti-vibration mount are taken into consideration.

It will be readily appreciated that the processing of the input and output data to derive the successive sets of effectiveness data will be carried out a time intervals. These time intervals can be fixed and/or take into account other factors such as the amplitude of the vibration input. For example, processing to derive the effectiveness data can be carried out once an hour or once a day—optionally using the input and output data collected continuously since the last processing event was carried out—or after a severe transient event when it might be useful to measure the effectiveness of the anti-vibration mount in case it has been damaged. If fixed time intervals are used then the time between processing events can be set depending on the environment in which the anti-vibration mount is being used. For example, if the mount is being used to support system critical equipment then a shorter time between processing events may be preferred.

Using the input and output data to determine the effectiveness of the anti-vibration mount makes inherent use of its dynamic stiffness without having to make any direct measurements or calculations of the stiffness model. As the anti-vibration mount deteriorates over its service life, the amplitude of the output vibrations will approach, and in some cases may even exceed, the input vibrations as resonances are introduced by the mount. The effectiveness of the anti-vibration mount includes damping and dynamic stiffness as a complex expression. Damage to, or defects in, the mount will typically affect the higher order frequency components more than the first order, and the overall effect would be to cause a reduction in the effectiveness over the whole frequency range. As used herein, the terms ‘higher order frequency components’ or ‘higher order components’ refer to one or more frequency components within the effectiveness data other than the first order component. As noted elsewhere, changes in damping are mainly reflected in changes to the amplitude and shape of a particular component (e.g., reduced damping results in a narrower peak and vice versa), whilst changes in stiffness are mainly reflected in changes to the frequency of a particular component.

The effectiveness data of the anti-vibration mount can be derived from the relationship between the input data and the output data at one or more frequencies. For example, the effectiveness E as a function of frequency can be determined by the equation:

$$E ( f ) = \frac{( {A}_{out} ( f ) - {A}_{in} ( f ) )}{{A}_{in} ( f )} \qquad ( EQ 1 )$$

where:

Aᵢₙ is input data indicative of the amplitude of the input vibrations applied to the mount, and

Aₒᵤₜ is output data indicative of the amplitude of the output vibrations.

As noted above, the effectiveness data can be derived using the whole frequency spectra of the input and output data or just one or more frequency components or peaks within the frequency spectra. In the case where only one frequency component of the input and output data is used then the effectiveness data can be expressed as a numerical value which represents both the damping and the dynamic stiffness of the mount for that frequency component and for the period of time over which the input and output data was collected. If more than one frequency component or the whole frequency spectra of the input and output data is used then the effectiveness data can be expressed as a function of frequency. Alternatively, further processing (e.g. an averaging step) can be carried out so that the effectiveness data can be expressed as a numerical value which represents both the damping and the dynamic stiffness of the mount for the particular frequency components selected, and for the period of time over which the input and output data was collected. Changes in the amplitude of one or more peaks within the frequency spectra of one or both of the output data and the effectiveness data can be attributed to changes in damping provided by the anti-vibration mount. Changes in the shape of one or more peaks can also be attributed to changes in damping. It is also possible to see how the frequency of one or more peaks within the frequency spectra of one or both of the output data and the effectiveness data changes over the service life of the mount. Such changes can be attributed to changes in the dynamic stiffness of the anti-vibration mount. One example might be changes to the frequency component that represents the standing wave frequency which can often provide useful information about the physical condition of the anti-vibration mount. Changes to one or more frequency components might be monitored by applying a peak detection function or a modified Hilbert transform to the frequency spectrum of the output data or effectiveness data, for example. It will therefore be readily appreciated that information on the effectiveness of the anti-vibration mount can be obtained by monitoring changes in one or both of the amplitude and frequency of one or more components within the various frequency spectra.

Once the effectiveness data for a particular time period has been determined then this can be used for condition monitoring of the anti-vibration mount. Important information on the operating condition of the anti-vibration mount can be obtained from just the first set of effectiveness data if the amplitude and/or frequency of one or more frequency components is compared against a threshold, for example. It will be expected that effectiveness will decrease during the service life of the anti-vibration mount and so any existing effectiveness data can be extrapolated and used to predict when the mount might need to be maintained or replaced. Damage from severe transient events can also be monitored by noting step-changes in successive sets of effectiveness data, for example. If additional effects such as internal resonances, standing waves and mass effects that are produced by the anti-vibration mount are taken into consideration then they can be particularly useful in assessing disbands, porosity and cracks in the mount which might indicate damage.

In one arrangement the anti-vibration mount consists of a plurality of elastomeric layers interleaved with rigid plates. The elastomeric layers may be made of any suitable material such as rubber, rubber mix or polymer, for example. Similarly, the rigid plates may be made of a suitable material, more particularly a rigid plate metal such as steel. The anti-vibration mount will typically have a compression axis along which a component of compression loading is applied, in use, and a pair of orthogonal shear axes. A component of shear loading may be applied to the anti-vibration mount along one or both of the shear axes depending on the overall design of any external support frame or structure. The compression axis will typically be substantially normal to the plane of the various elastomeric layers and interleaved rigid plates and the shear axes will typically be substantially parallel to the plane of the various elastomeric layers and interleaved rigid plates.

If the anti-vibration mount is positioned between a stator assembly of a rotating electrical machine and an external support frame then it will typically be located with its compression axis (i.e. the axis normal to the plane of the elastomeric layers and interleaved rigid plates) aligned substantially with a tangent of the stator and one of its shear axis being aligned substantially with a radius of the stator. In this case the damping and dynamic stiffness that is important is that for compression loading.

The step of determining the effectiveness data may also take into account the operating temperature of the mount because this has an effect on the dynamic stiffness. In other words, the effectiveness data of the anti-vibration mount can be ‘normalised’ for operating temperature. In one example then:

Eₙ(f)=E(f)kₜkₐ (EQ2)

where:

Eₙ(f) is normalised effectiveness data,

kₜ is a factor that adjusts for temperature, and

kₐ is a factor that adjusts for amplitude.

In the case where the anti-vibration mount is positioned between a stator assembly of a rotating electrical machine and an external support frame then a temperature sensor can be used to measure the stator temperature or air flow temperature, for example. Temperature sensors are typically positioned at various locations in any electrical machine for general monitoring purposes and the measurements can simply be used by the processor unit when deriving the effectiveness data. Any suitable temperature sensor can be used. The processing of the input and output data to derive the first set (or the successive sets) of effectiveness data can be done when the measured or derived operating temperature of the anti-vibration mount is within a predetermined temperature range. This may remove the requirement for the effectiveness data to be normalised for temperature.

One embodiment of the present invention further provides an apparatus for condition monitoring of an anti-vibration mount comprising: first means for measuring or deriving input data indicative of the amplitude of input vibrations that are applied to the anti-vibration mount; second means for measuring or deriving output data indicative of the amplitude of corresponding output vibrations of the anti-vibration mount; and a processor unit adapted to determine a first set of effectiveness data indicative of the effectiveness of the anti-vibration mount using input and output data measured or derived over a first period of time, and to monitor the operating condition of the anti-vibration mount on the basis of the first set of effectiveness data.

The processor unit can be further adapted to determine a second set of effectiveness data indicative of the effectiveness of the anti-vibration mount using input and output data measured or derived over a second period of time, different from the first period of time, and to monitor the operating condition of the anti-vibration mount on the basis of the first and second sets of effectiveness data. Further sets of effectiveness data can be determined in a similar manner as described above.

An assembly can include an anti-vibration mount and the apparatus described above.

The assembly can further comprise a stator assembly for a rotating electrical machine and an external support frame, the anti-vibration mount being located between the external support frame and a part of the stator assembly such that it experiences compression loading in a substantially tangential direction of the stator assembly and radial shear loading in a substantially radial direction of the stator assembly during operation of the rotating electrical machine.

### DRAWINGS

FIG. 1 shows a perspective view of part of a stator assembly for a rotating electrical machine that is secured to an external support frame by means of a sandwich anti-vibration mount, the condition of which is monitored in accordance with the one embodiment of the present invention;

FIG. 2 shows acceleration data as a function of time;

FIG. 3 shows acceleration data as a function of frequency;

FIG. 4 shows normalised effectiveness data as a function of frequency;

FIG. 5 shows how the dynamic stiffness of the mount varies with amplitude of the input vibrations applied to the mount;

FIG. 6 shows how the dynamic stiffness of the mount varies with temperature of the mount; and

FIG. 7 shows how normalised effectiveness data can be compared to provide condition monitoring of the mount.

### DETAILED DESCRIPTION

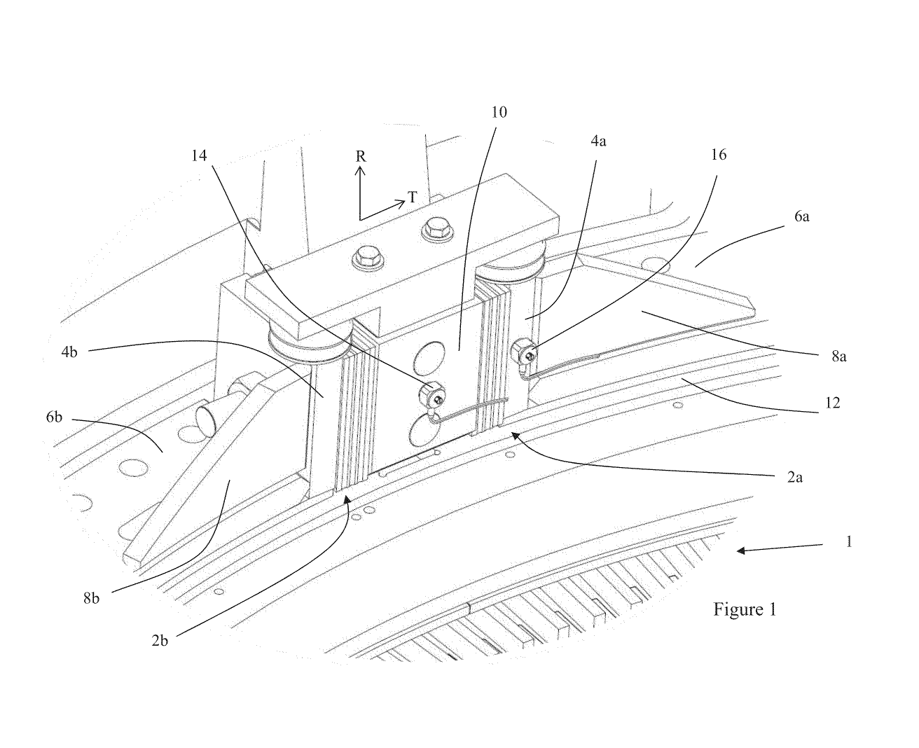

FIG. 1 shows part of a stator assembly 1 for a rotating electrical machine, e.g. a motor or generator.

An external support frame is located outside the stator assembly 1. Each axial end of the stator assembly is indirectly connected to structural members of the external support frame at separate mounting locations that are typically spaced around the circumference of the stator assembly.

Each mounting location includes a pair of co-located mounts 2a, 2b. One mount in each pair experiences an increased compression load when a rotor (not shown) rotates within the stator assembly 1 in a first direction and the other mount in each pair experiences an increased compression load when the rotor rotates in an opposite direction. A first sandwich anti-vibration mount 2a includes a rigid end support member that includes a reaction plate 4a, a mounting plate 6a and a support bracket 8a. Similarly, a second sandwich anti-vibration mount 2b includes a rigid end support member that includes a reaction plate 4b, a mounting plate 6b and a support bracket 8b. The mounting plates 6a, 6b include openings to enable the end support members to be mechanically secured to circumferentially-spaced parts of the external support frame 12 by bolts.

A rigid intermediate support member 10 is located between the first and second mounts 2a, 2b and is mechanically secured to the stator assembly 1.

The first and second mounts 2a, 2b have three elastomeric layers interleaved with two intermediate rigid plates. The elastomeric layers and interleaved rigid plates are located between the reaction plates 4a, 4b and oppositely facing surfaces of the intermediate support member 10 and shown in FIG. 1.

It will be readily appreciated that there is no direct physical connection between the stator assembly 1 and the external support frame 12. More particularly, the indirect connection between the stator assembly 1 and the structural members of the external support frame 12 is made through the intermediate support member 10 and the end support members of the first and second mounts 2a, 2b at each mounting location. Any relative movement between the stator assembly 1 and the external support frame 12 in the radial direction (R) is experienced by the co-located mounts as radial shear loading along their radial shear axes and any relative movement between the stator assembly and the external support frame in the tangential direction (T) is experienced by one of the co-located mounts as an increased compression load (i.e. a compression load that is greater than the steady-state compression load) and by the other mount as a reduced compression load that is less than the steady-state compression load.

In use, the mounts 2a, 2b receive input vibrations from the stator assembly 1—in the form of transient compression loads—through the intermediate support member 10 and these are transferred into the external support frame 12. A first high-frequency accelerometer 14 is mounted on the intermediate support member 10 and provides acceleration data indicative of the input vibrations applied to the first mount 2a. A second high-frequency accelerometer 16 is mounted on the reaction plate 4a of the first mount 2a and provides acceleration data indicative of the output vibrations, i.e. the vibrations that are transferred through the mount to the external support frame 12. Although not shown, a third high-frequency accelerometer can be mounted on the reaction plate 4b of the second mount 2b to provide condition monitoring of the second mount. It will also be readily appreciated that the accelerometers 14, 16 can be mounted at other locations on the stator assembly and the external support frame, and can also be physically incorporated within the actual mount.

The accelerometers 14, 16 are connected to a processor unit (not shown) by cables. Input and output data from the accelerometers 14, 16 is provided to the processor unit which carries out the processing for determining the condition monitoring of the first mount 2a. The processor unit can be a stand-alone unit or can be integrated with a processor unit or that is used for general monitoring and/or control of the electrical machine.

The process of determining the effectiveness of the first mount 2a and how this can be used to monitor its operating condition will now be explained in more detail.

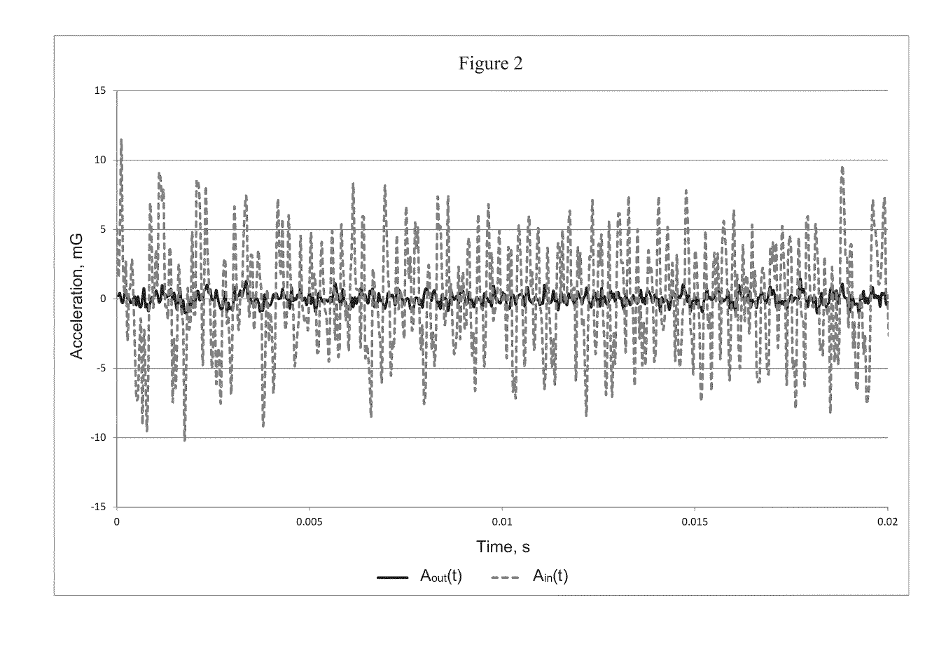

FIG. 2 shows raw acceleration data that is received from both accelerometers 14.16 over a period of 0.02 s. In practice, acceleration data will typically be obtained for a much longer period of time while the electrical machine is operating and can be stored in a suitable memory until it is processed. It can be seen that the amplitude of the input vibrations Aᵢₙ (i.e. the acceleration data provided by the first accelerometer 14 that is mounted to the intermediate support member 10) is much greater than the amplitude of the corresponding output vibrations Aₒᵤₜ (i.e. the acceleration data provided by the second accelerometer 16) because of the damping effect of the first mount 2a for compression loading.

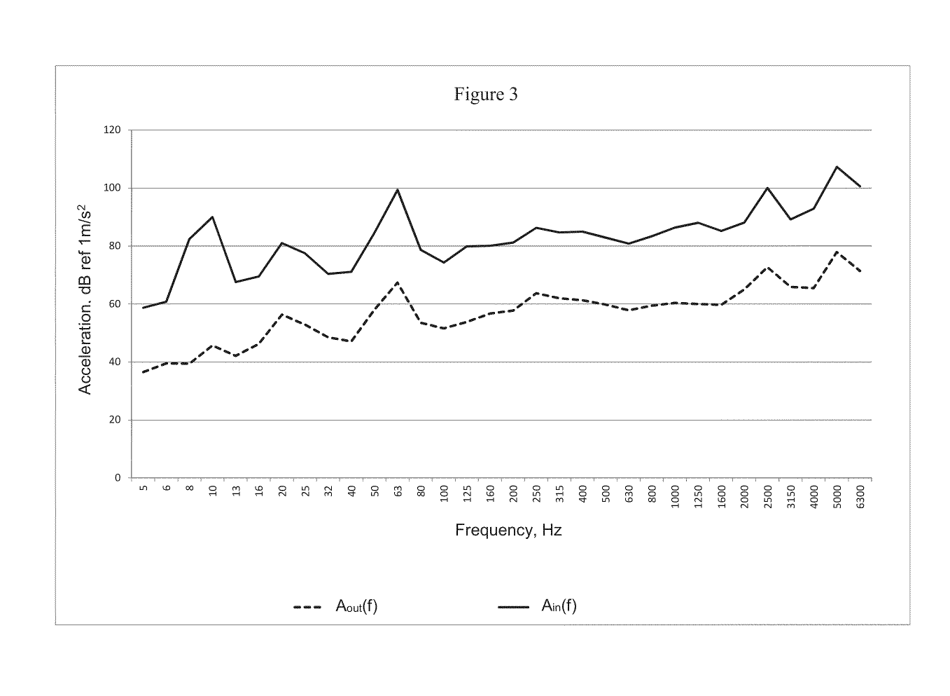

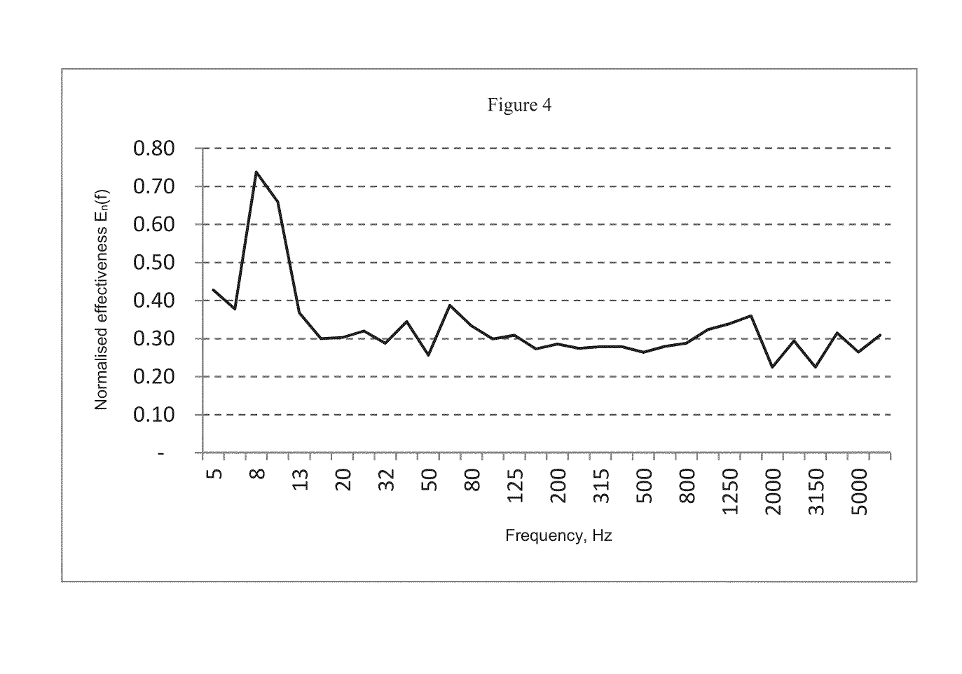

FIG. 3 shows the acceleration data after it has been converted from the time domain to the frequency domain using an appropriate transform. It can be seen that the anti-vibration mount is particularly effective at minimising the transfer of vibrations at certain frequencies, e.g. between about 6 and 12 Hz. This can also be seen in FIG. 4 which is described in more detail below.

FIG. 4 shows normalised effectiveness data derived from the acceleration data. The normalised effectiveness Eₙ as a function of frequency can be determined by the equation:

$${E}_{n} ( f ) = ( \frac{( {A}_{out} ( f ) - {A}_{in} ( f )}{{A}_{in} ( f )} ) {k}_{t} {k}_{a} \qquad ( EQ 3 )$$

where:

Aᵢₙ is the acceleration data for the input vibrations applied to the first mount 2a,

Aₒᵤₜ is the acceleration data for the output vibrations,

kₜ is a factor that adjusts for temperature, and

kₐ is a factor that adjusts for amplitude.

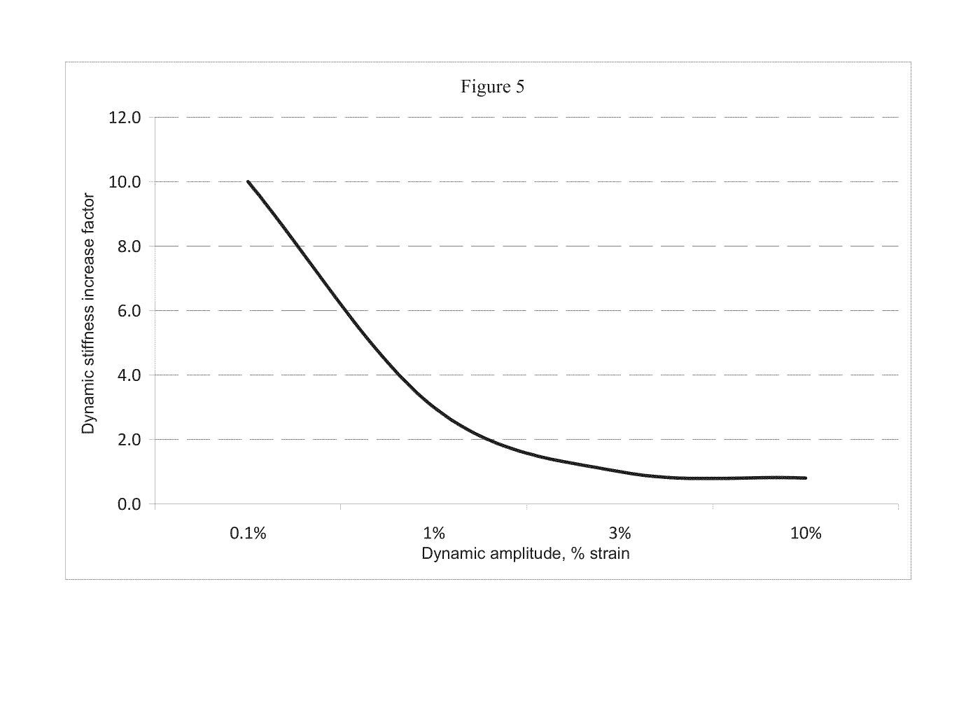

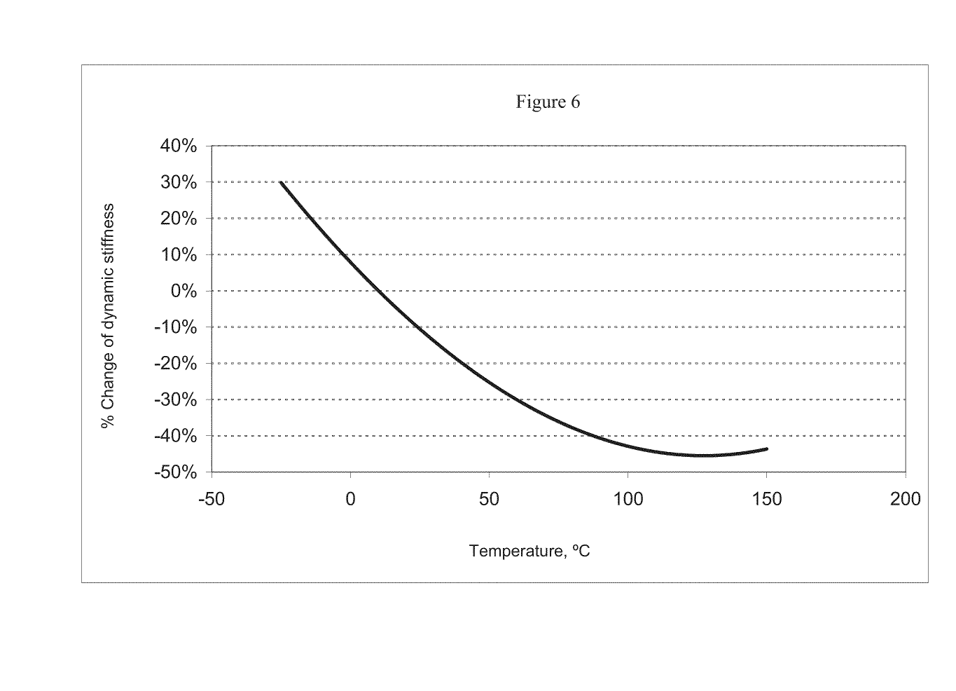

As noted above, the effectiveness of the first mount 2a will depend on both its damping and its dynamic stiffness. Its dynamic stiffness in turn depends on the amplitude of the input vibrations and the operating temperature of the mount. FIGS. 5 and 6 show how dynamic stiffness varies with amplitude and temperature, respectively. The temperature factor kₜ can be based on a measured temperature provided by a temperature sensor (not shown) located at or adjacent the first mount 2a. The effectiveness data shown in FIG. 4 is therefore ‘normalised’ for an operating temperature of 90° C. and amplitude of about 1%.

The operating condition of the first mount 2a can then be monitored by comparing effectiveness data determined periodically at time intervals.

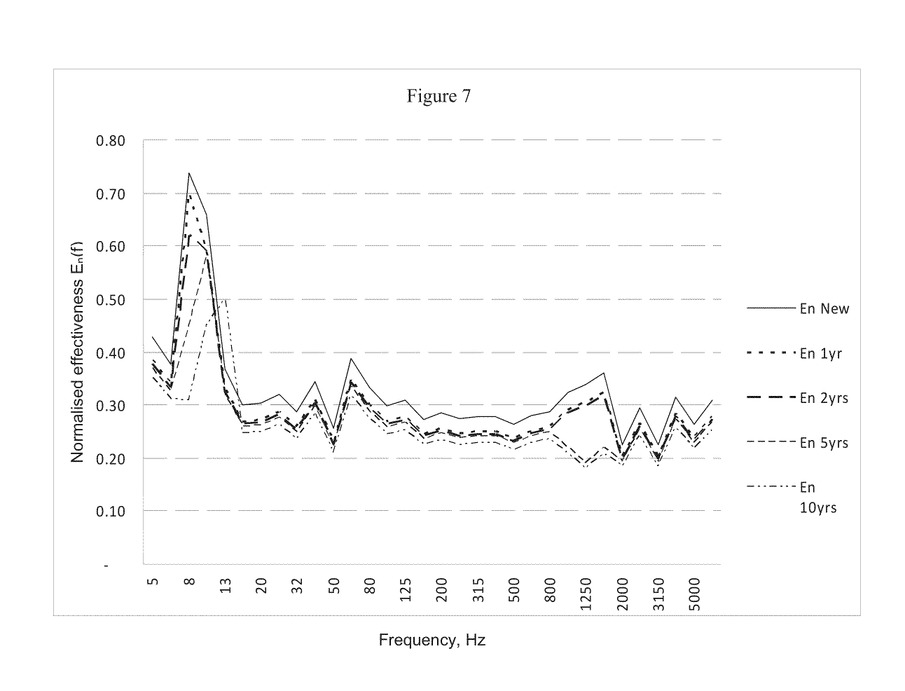

FIG. 7 shows successive sets of normalised effectiveness data determined using acceleration data collected when the first mount 2a was installed in the stator assembly and then after 1 year, 2 years, 5 years and 10 years of service life. For example, acceleration data can be collected for a particular period of time when the mount is first installed and this is used to determine a first set of effectiveness data labelled ‘En new’ in FIG. 7. Acceleration data is then collected for a particular period of time after 1 year of service life and this is used to determine a second set of effectiveness data labelled ‘En 1 year’ in FIG. 7. Acceleration data is then collected for a particular period of time after 2 years of service life and this is used to determine a third set of effectiveness data labelled ‘En 2 years’ in FIG. 7. Acceleration data is then collected for a particular period of time after 5 years of service life and this is used to determine a fourth set of effectiveness data labelled ‘En 5 years’ in FIG. 7. Finally, acceleration data is collected for a particular period of time after 10 years of service life and this is used to determine a fifth set of effectiveness data labelled ‘En 10 years’ in FIG. 7.

If the sets of effectiveness data are compared then it can be seen that there is a general reduction in the effectiveness of the first mount 2a as a result of its physical deterioration. For example, the reduction in effectiveness at a frequency of about 8 Hz can be attributed to the breakdown in the base polymer that forms the elastomeric layers of the mount due to aging, i.e. deterioration in the damping effect. The reduction in effectiveness at a frequency of about 1250 Hz can be attributed to damage suffered by the first mount 2a during its service life and which changes its dynamic response. As well as a reduction in the amplitude of the peaks representing various frequency components within the effectiveness data, it can also be seen that the shape and frequency of the peaks changes over the service life of the first mount 2a. The changes in peak frequency are generally a result of changes in the dynamic stiffness of the first mount 2a while changes in the amplitude and shape of the peaks are generally a result of changes in damping.

The reduction in effectiveness can be monitored in this way without the need to visually inspect or monitor the condition of the mount. The future effectiveness of the mount can be extrapolated using the existing effectiveness data to predict when the first mount 2a might need to be maintained or replaced. For example, the first mount 2a might need to be replaced if the amplitude of a certain component is likely to fall below a certain amplitude threshold or some other minimum operating condition is exceeded because of a deterioration in the damping effect, or if the frequency of a certain component (e.g., a peak in the effectiveness data caused by standing waves or mass effects) is likely to exceed a certain frequency threshold because of deterioration in the dynamic stiffness. Replacement of the first mount 2a can be scheduled to coincide with routine maintenance of the electrical machine so that non-operational time can be minimised.

It is also possible to provide condition monitoring of the first mount 2a by processing or analysing a single set of effectiveness data, i.e. without comparing it against existing effectiveness data or making any attempt to extrapolate the future effectiveness of the mount. In the case of the sets of effectiveness data shown in FIG. 7, each set could be processed to see if the first mount 2a is meeting minimum requirements for damping or dynamic stiffness, for example. This could be done by applying a threshold to the normalised effectiveness data. In one example, steps could be taken to schedule maintenance or replacement of the mount if the amplitude of normalised effectiveness at a frequency of about 8 Hz falls below a threshold value of 0.50. In this case, it can be seen that the fifth set of effectiveness data collected after a service life of 10 years would be at about this threshold value and the first mount 2a could then be replaced before it suffers any further breakdown in the base polymer that forms the elastomeric layers. A similar threshold value could also be applied at a frequency of about 1250 Hz which provides an indication of the damage caused during normal operation of the first mount 2a during its service life.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of monitoring an operating condition of an anti-vibration mount, the method comprising:
determining a first set of effectiveness data indicative of the effectiveness of the anti-vibration mount by:
measuring or deriving first input data indicative of the amplitude of input vibrations that are applied to the anti-vibration mount and first output data indicative of the amplitude of corresponding output vibrations of the anti-vibration mount, the first input data and the first output data being measured over a first period of time; and
using the input data and the output data to determine the first set of effectiveness data; and
monitoring the operating condition of the anti-vibration mount on the basis of the first set of effectiveness data.

2. The method of monitoring according to claim 1, wherein monitoring the operating condition of the anti-vibration mount comprises comparing the frequency of a component within the first set of effectiveness data against a frequency threshold.

3. The method of monitoring according to claim 1, wherein monitoring the operating condition of the anti-vibration mount comprises comparing the amplitude of a component within the first set of effectiveness data against an amplitude threshold.

4. (canceled)

5. The method of monitoring according to claim 1, further comprising:
determining a second set of effectiveness data indicative of the effectiveness of the anti-vibration mount by:
measuring or deriving second input data indicative of the amplitude of input vibrations that are applied to the anti-vibration mount and second output data indicative of the amplitude of corresponding output vibrations of the anti-vibration mount, the second input data and the second output data being measured or derived over a second period of time, different from the first period of time; and
using the second input data and the second output data measured or derived over the second period of time to determine the second set of effectiveness data; and
monitoring the operating condition of the anti-vibration mount on the basis of the first set of effectiveness data and the second set of effectiveness data.

6. The method of monitoring according to claim 5, wherein monitoring the operating condition of the anti-vibration mount comprises comparing and/or extrapolating the first set of effectiveness data and the second set of effectiveness data.

7. The method of monitoring according to claim 5, wherein monitoring the operating condition of the anti-vibration mount comprises comparing the frequency of a component within the first set of effectiveness data against the frequency of the same component within the second set of effectiveness data.

8. The method of monitoring according to claim 5, wherein monitoring the operating condition of the anti-vibration mount comprises comparing the amplitude of a component within the first set of effectiveness data against the amplitude of the same component within the second set of effectiveness data.

9. (canceled)

10. The method of monitoring according to claim 1, further comprising:
measuring or deriving the operating temperature of the anti-vibration mount; and
using the measured operating temperature to normalize the first set of effectiveness data.

11. The method of monitoring according to claim 5, further comprising:
measuring or deriving the operating temperature of the anti-vibration mount; and
using the measured operating temperature to normalize the first set of effectiveness data and/or the second set of effectiveness data.

12. An apparatus for monitoring an operating condition of an anti-vibration mount, the apparatus comprising:
a first calculator configured to measure or derive first input data indicative of the amplitude of input vibrations that are applied to the anti-vibration mount;
a second calculator configured to measure or derive first output data indicative of the amplitude of corresponding output vibrations of the anti-vibration mount; and
a processor unit configured to determine a first set of effectiveness data indicative of the effectiveness of the anti-vibration mount using the first input data and the first output data measured or derived over a first period of time, and to monitor the operating condition of the anti-vibration mount on the basis of the first set of effectiveness data.

13. The apparatus according to claim 12, wherein the processor unit is further configured to monitor the operating condition of the anti-vibration mount by comparing the frequency of a component within the first set of effectiveness data against a frequency threshold.

14. The apparatus according to claim 12, wherein the processor unit is further configured to monitor the operating condition of the anti-vibration mount by comparing the amplitude of a component within the first set of effectiveness data against an amplitude threshold.

15. (canceled)

16. The apparatus according to claim 12, wherein the processor unit is further configured to determine a second set of effectiveness data indicative of the effectiveness of the anti-vibration mount using second input data and second output data measured or derived over a second period of time, different from the first period of time, and to monitor the operating condition of the anti-vibration mount on the basis of the first set of effectiveness data and the second set of effectiveness data.

17. The apparatus according to claim 16, wherein the processor unit is further configured to monitor the operating condition of the anti-vibration mount by comparing the frequency of a component within the first set of effectiveness data against the frequency of the same component within the second set of effectiveness data.

18. The apparatus according to claim 16, wherein the processor unit is further configured to monitor the operating condition of the anti-vibration mount by comparing the amplitude of a component within the first set of effectiveness data against the amplitude of the same component within the second set of effectiveness data.

19. (canceled)

20. (canceled)

21. The apparatus according to claim 20, wherein the processor unit is further configured to normalize the first set of effectiveness data using a measured operating temperature provided by a temperature sensor.

22. (canceled)

23. The apparatus according to claim 22, wherein the processor unit is further configured to normalize the first set of effectiveness data and/or the second set of effectiveness data using a measured operating temperature provided by a temperature sensor.

24. The apparatus according to claim 12, wherein the first calculator and the second calculator comprise accelerometers located at or adjacent the anti-vibration mount.

25. An assembly comprising:
an anti-vibration mount; and
an apparatus for monitoring an operating condition of the anti-vibration mount, the apparatus comprising:
a first calculator configured to measure or derive first input data indicative of the amplitude of input vibrations that are applied to the anti-vibration mount;
a second calculator configured to measure or derive first output data indicative of the amplitude of corresponding output vibrations of the anti-vibration mount; and
a processor unit configured to determine a first set of effectiveness data indicative of the effectiveness of the anti-vibration mount using the first input data and the first output data measured or derived over a first period of time, and to monitor the operating condition of the anti-vibration mount on the basis of the first set of effectiveness data.

26. An The assembly according to claim 25, wherein the anti-vibration mount comprises a plurality of elastomeric layers interleaved with rigid plates.

27. The assembly according to claim 25, further comprising:
a stator assembly for a rotating electrical machine; and
an external support frame,
wherein the anti-vibration mount is located between the external support frame and a part of the stator assembly such that the anti-vibration mount experiences compression loading in a substantially tangential direction of the stator assembly and radial shear loading in a substantially radial direction of the stator assembly during operation of the rotating electrical machine.
